(19) United States
(12) Patent Application Publication
(10) Pub. No.: US 2025/0301235 A1
(43) Pub. Date: Sep. 25, 2025

(54) TRACKING SYSTEM ADAPTABLE TO TRACKING AN OBJECT

(71) Applicant: Himax Imaging Limited, Tainan City (TW)

(72) Inventors: Biing-Seng Wu, Tainan City (TW); Yu-Yu Sung, Tainan City (TW); Tsung-Chi Chang, Tainan City (TW)

(21) Appl. No.: 18/616,066

(22) Filed: Mar. 25, 2024

(51) Int. Cl. H04N 25/44; G06T 7/20; H04N 23/667; H04N 25/46

(52) U.S. Cl. CPC H04N 25/44; G06T 7/20; H04N 23/667; H04N 25/46

(57) ABSTRACT

A tracking system adaptable to tracking an object includes an image sensor that converts light into image signals representing a captured image; a motion block detector that detects motion of the object according to the captured image, the captured image being divided into a plurality of detection blocks and detection blocks with motion detected are referred to as motion blocks; and a region of interest (ROI) determinator configured to determine an ROI that covers the motion blocks and to generate an ROI setting associated with the determined ROI. The generated ROI setting is applied to the image sensor such that only pixel sensors located within the determined ROI are active in future capturing for tracking the object.

### BACKGROUND OF THE INVENTION

### 1. Field of the Invention

The present invention generally relates to a tracking system, and more particularly to a tracking system adaptable to tracking an object with region of interest (ROI).

### 2. Description of Related Art

Image tracking is a technique that involves identifying and tracking the presence and movement of specific images or visual patterns in different scenarios. Image tracking can be used for various purposes, such as augmented reality, face recognition, object detection, surveillance, medical imaging, and more. Image tracking can be performed using different methods, such as feature-based, template-based, or deep learning-based approaches. Image tracking requires a robust and efficient algorithm that can handle various challenges, such as occlusion, illumination changes, scale variations, and background clutter.

To track a moving object from a sensor with motion detect information, the following steps are conventionally performed. First, one need to initialize the sensor and configure its parameters, such as the resolution, frame rate, and sensitivity. Second, one need to read the sensor data and apply a motion detection algorithm, such as background subtraction, optical flow, or deep learning. This will produce a binary mask that indicates the presence or absence of motion in each pixel. Third, one need to extract the features of the moving object, such as its centroid, bounding box, contour, or keypoints. Methods such as connected components, contour detection, or feature matching may be used. Fourth, one need to track the moving object across multiple frames, using techniques such as Kalman filter, particle filter, or tracking-by-detection. This will provide object's trajectory and state estimation. Finally, one need to display or store the tracking results, depending on required application. Methods such as drawing overlays, saving videos, or sending data to other devices may be used.

One of the challenges in designing a sensor system for object detection and tracking is to balance the power consumption and the accuracy of the sensor. A need has thus arisen to propose a novel tracking system that uses less power consumption to detect and can also track the moving object with performance and advantages over existing methods.

### SUMMARY OF THE INVENTION

In view of the foregoing, it is an object of the embodiment of the present invention to provide a tracking system adaptable to tracking an object with region of interest (ROI) capable of substantially reducing power consumption and the amount of calculation.

According to one embodiment, a tracking system adaptable to tracking an object includes an image sensor, a motion block detector and a region of interest (ROI) determinator. The image sensor converts light into image signals representing a captured image. The motion block detector detects motion of the object according to the captured image, the captured image being divided into a plurality of detection blocks and detection blocks with motion detected are referred to as motion blocks. The ROI determinator is configured to determine an ROI that covers the motion blocks and to generate an ROI setting associated with the determined ROI. The generated ROI setting is applied to the image sensor such that only pixel sensors located within the determined ROI are active in future capturing for tracking the object.

### BRIEF DESCRIPTION OF THE DRAWINGS

FIG. 1 shows a block diagram illustrating a tracking system adaptable to tracking an object according to one embodiment of the present invention;

FIG. 2 shows an exemplary captured image that is divided into 16×8 detection blocks and a map stored in a register that illustrates position relationship between detection blocks and the captured image containing a person walking;

FIG. 3A shows an exemplary captured image with (slashed) motion blocks; and

FIG. 3B shows the determined ROI that covers the motion blocks.

### DETAILED DESCRIPTION OF THE INVENTION

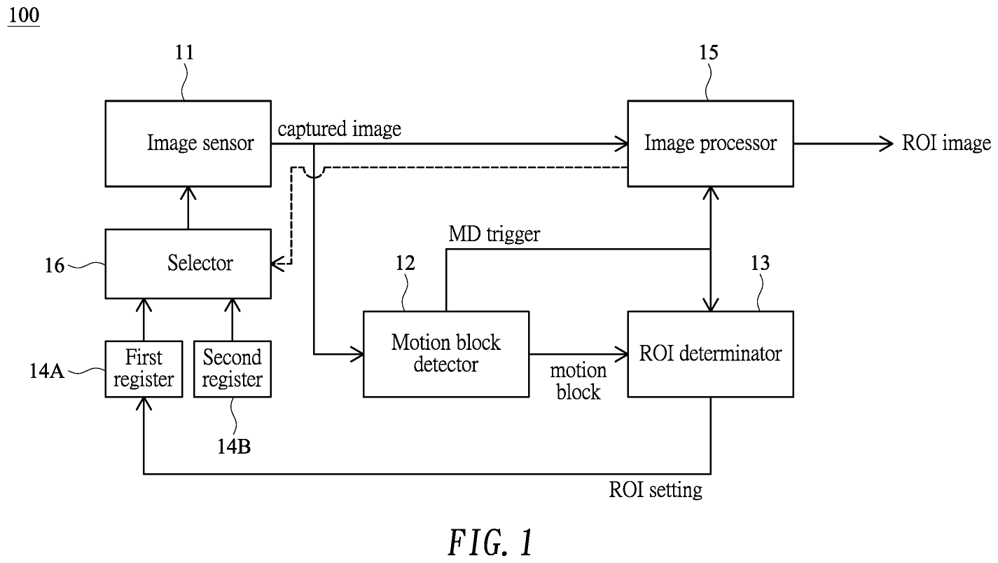

FIG. 1 shows a block diagram illustrating a tracking system 100 adaptable to tracking an object (e.g., a person) according to one embodiment of the present invention.

In the embodiment, the tracking system 100 may include an image sensor 11 composed of a plurality of pixel sensors configured to convert light into image signals representing a captured image. In one exemplary embodiment, the image sensor 11 may include a complementary metal-oxide-semiconductor (CMOS) image sensor with a resolution of 2048×2048 (that is, 2048 pixels in width and 2048 pixels in height).

The tracking system 100 of the embodiment may include a motion block detector 12 configured to detect motion of an object according to the captured image (of the image sensor 11). Conventional image processing technique may be adopted to perform motion detection in the motion block detector 12. Alternatively, artificial intelligence (AI) may be adopted to perform motion detection in the motion block detector 12, details of which are omitted for brevity.

One of the common methods to detect objects in a video stream is to use motion detection and AI identification algorithms. These algorithms can work with low resolution images, as they do not require a lot of details to perform the analysis. To optimize the computing power and reduce the risk of missing objects, the algorithms can use smaller images with larger fields of view (FOV).

Pixel binning is a technique commonly used to improve image quality and reduce noise by combining adjacent pixels, for example, 8×8 pixels (that is, with a binning ratio of 8), into superpixels. Taking an image sensor 11 with 2048×2048 resolution as an example, a captured image with a binning ratio of 8 will result in 256×256 superpixels. Although the captured image is subjected to pixel binning in the embodiment, it is appreciated that, in an alternative embodiment, the captured image need not be subjected to pixel binning.

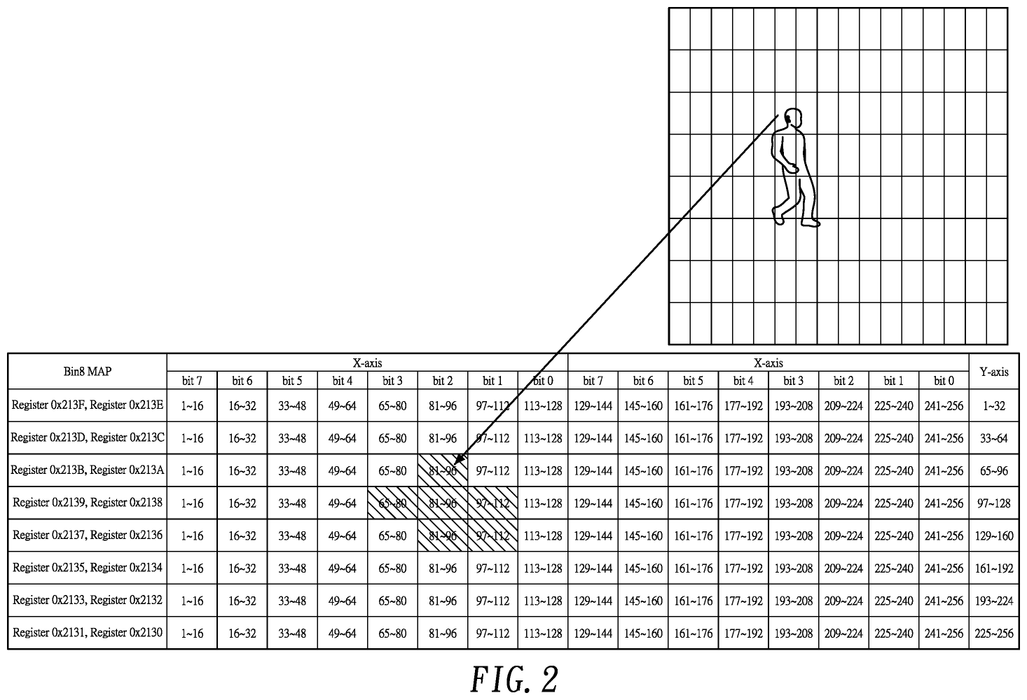

According to one aspect of the embodiment, the motion block detector 12 detects motion of the object with a block-based motion detection scheme. Specifically, the captured image is divided into a plurality of detection blocks. For example, in the embodiment, adjacent superpixels may be grouped into detection blocks. FIG. 2 shows an exemplary captured image (captured by an image sensor 11 with 2048×2048 resolution and a binning ratio of 8) that is divided into 16×8 detection blocks, each having 16×32 superpixels. FIG. 2 further shows a map stored in a register that illustrates position relationship between detection blocks and the captured image containing a person walking. As exemplified in FIG. 2, detection blocks with slashes represent detection blocks with motion detected (by the motion block detector 12), and are hereinafter referred to as motion blocks. The motion blocks may be recorded in an associated register. Taking the same image sensor 11 with 2048×2048 resolution as another example, a captured image with a binning ratio of 4 will result in 512×512 superpixels, and the captured image is divided into 16×8 detection blocks, each having 32×64 superpixels.

In the embodiment, the tracking system 100 may include a region of interest (ROI) determinator 13 configured to determine an ROI that covers the motion blocks and to generate an ROI setting associated with the determined ROI. According to another aspect of the embodiment, the generated ROI setting is then applied to the image sensor 11 such that only pixel sensors correspondingly located within the determined ROI are active (that is, capable to respond to incoming light and convert it into image signals) in future capturing for tracking the object while other pixel sensors (out of the determined ROI) are inactive in the future capturing. Therefore, power consumption and the amount of calculation may be significantly reduced.

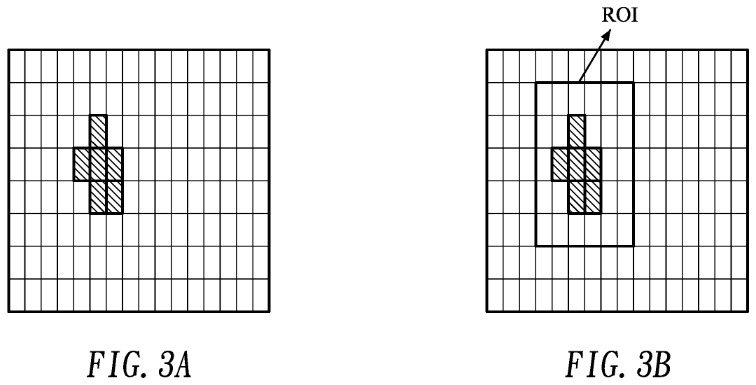

FIG. 3A shows an exemplary captured image with (slashed) motion blocks, and FIG. 3B shows the determined ROI that covers the motion blocks. As exemplified in FIG. 3B, in addition to covering the motion blocks, the determined ROI may also include some non-motion blocks surrounding the motion blocks. In another embodiment, ROI may be determined based on a center of gravity of the motion blocks.

One way to improve the user experience of image capture is to provide a high-resolution region of interest (ROI) function. This allows the user to zoom in on the object part they want to see more clearly, without losing quality. A high-resolution ROI also has benefits for data transmission, power efficiency, storage space and AI processing. It reduces the amount of data that needs to be sent, consumed, stored and analyzed, which can save time and resources.

According to a further aspect of the embodiment, the tracking system 100 may include a first register 14A configured to store the ROI setting to be applied to the image sensor 11 when motion of the object is detected by the motion block detector 12 (and the ROI is determined by the ROI determinator 13). The tracking system 100 may include a second register 14B configured to store a default setting to be applied to the image sensor 11 when motion of the object is not detected (and the ROI is not determined). The default setting may, for example, define all pixel sensors of the image sensor 11 to be active in future capturing.

The tracking system 100 of the embodiment may include an image processor 15 configured to generate an ROI image according to the captured image (from the image sensor 11) and the ROI (determined by the ROI determinator 13).

In one exemplary embodiment, the image sensor 11 and the motion block detector 12 are integrated, and the ROI determinator 13 and the image processor 14 are implemented in a system on a chip (SoC), which may be woken up by a motion detection (MD) trigger (generated by the motion block detector 12) when motion is detected by the motion block detector 12.

In the embodiment, the tracking system 100 may include a selector 16 configured to select either the ROI setting as stored in the first register 14A to be applied to the image sensor 11 (when motion of the object is detected), or the default setting as stored in the second register 14B to be applied to the image sensor 11 (when motion of the object is not detected). In one exemplary embodiment, the selector 16 may be controlled by the image processor 15 as shown by the dotted line with arrow. In an alternative embodiment (not shown), the selector 16 may be controlled by the motion block detector 12 or the ROI determinator 13.

The tracking system 100 of the embodiment may be customized according to the application requirements. The size and the field of view (FOV) of the detection part can be adjusted as needed. The detection frequency can also vary from a few seconds to minutes depending on the situation. Once an event is detected, the system on chip (SoC) can activate other functions such as tracking, digital zoom, or region of interest (ROI) analysis.

Although specific embodiments have been illustrated and described, it will be appreciated by those skilled in the art that various modifications may be made without departing from the scope of the present invention, which is intended to be limited solely by the appended claims.

What is claimed is:

1. A tracking system adaptable to tracking an object, comprising:
an image sensor that converts light into image signals representing a captured image;
a motion block detector that detects motion of the object according to the captured image, the captured image being divided into a plurality of detection blocks and detection blocks with motion detected are referred to as motion blocks; and
a region of interest (ROI) determinator configured to determine an ROI that covers the motion blocks and to generate an ROI setting associated with the determined ROI;
wherein the generated ROI setting is applied to the image sensor such that only pixel sensors located within the determined ROI are active in future capturing for tracking the object.

2. The system of claim 1, wherein the image sensor comprises a complementary metal-oxide-semiconductor (CMOS) image sensor.

3. The system of claim 1, wherein the motion block detector adopts image processing technique or artificial intelligence (AI) to perform motion detection.

4. The system of claim 1, wherein the captured image is subjected to pixel binning before motion detection by the motion block detector.

5. The system of claim 1, wherein the determined ROI covers the motion blocks and some non-motion blocks surrounding the motion blocks.

6. The system of claim 1, wherein the ROI is determined based on a center of gravity of the motion blocks.

7. The system of claim 1, further comprising:
a first register that stores the ROI setting to be applied to the image sensor when motion is detected by the motion block detector; and
a second register that stores a default setting to be applied to the image sensor when motion is not detected.

8. The system of claim 7, wherein the default setting defines all pixel sensors of the image sensor to be active in future capturing.

9. The system of claim 7, further comprising:
an image processor that generates an ROI image according to the captured image and the determined ROI.

10. The system of claim 9, wherein the motion block detector wakes up the ROI determinator and the image processor when motion is detected by the motion block detector.

11. The system of claim 9, wherein the image sensor and the motion block detector are integrated, and the ROI determinator and the image processor are implemented in a system on a chip (SoC).

12. The system of claim 9, further comprising:
a selector that controllably selects either the ROI setting as stored in the first register to be applied to the image sensor or the default setting as stored in the second register to be applied to the image sensor.

13. The system of claim 12, wherein the selector is controlled by the image processor.

14. The system of claim 12, wherein the selector is controlled by the motion block detector or the ROI determinator.
